(19) United States
(12) Patent Application Publication
(10) Pub. No.: US 2010/0226734 A1
(43) Pub. Date: Sep. 9, 2010

(54) Hardcover assembly arrangement and method

(76) Inventors: Kevin P. Parker, Berkeley, CA (US); Nicholas G. Paget, San Francisco, CA (US)

Correspondence Address: GIRARD & EQUITZ LLP, P.O. BOX 1369, LAFAYETTE, CA, 94549-1369, US

(21) Appl. No.: 12/380,678

(22) Filed: Mar. 3, 2009

(51) Int. Cl. B42C 11/00

(52) U.S. Cl. 412/4; 412/17

(57) ABSTRACT

A hardcover assembly arrangement including first and second hardcover assemblies, with each assembling including a layer of pressure sensitive adhesive disposed on a first surface of the hardcover assembly and additional pressure sensitive adhesive disposed on a second surface of the hardcover assembly, opposite the first surface. Each assembly includes a release liner disposed over and contacting the layer of pressure sensitive adhesive on the hardcover assembly, with the first and second hardcover assemblies being positioned relative to one another such that the release liner of the first hardcover assembly is disposed over and contacts the additional pressure sensitive adhesive of the second hardcover assembly.

### BACKGROUND OF THE INVENTION

1. Field of the Invention

The present invention relates generally to the field of book binding and, in particular, to a hardcover arrangement for use in encasing a bound book in a hardcover.

2. Description of Related Art

Binding systems for binding stacks of sheets into a book using desktop equipment is well known. Such books typically utilize soft covers. In addition, various approaches have also been developed that permit such books to be encased in a hardcover, again using desktop equipment. FIG. 1 shows an exemplary prior art hardcover assembly, generally designated by the numeral 20, which can be applied to a bound stack of sheets. Preferably the hardcover assembly 20 is preassembled using mass manufacturing techniques so that an end user can then encase a bound book with the assembly using low cost desktop equipment. Assembly 20 is further adapted to permit the end user to apply a custom cover, sometimes referred to as an over-wrap sheet, to the preassembled hardcover assembly, again using desktop equipment.

The hardcover assembly 20 includes a pair of cover boards 20A and 20B, typically made from a relatively rigid material such as cardboard. The cover boards 20A/20B have respective dimension that generally correspond to those of the pages of the bound stack (not depicted) that is to be encased in the hardcover assembly. The hardcover assembly further includes a spine board 20C, typically made of the same material as the cover boards 20A/20B. The spine board 20C has a width slightly greater than the thickness of the bound stack and a length that generally corresponds to the length of the stack. The spine board 20C is spaced apart from the cover boards to form a pair of gutter regions as will be described.

Exemplary dimensions of the various components of assembly 20 will be provided for a book which includes a stack of bound sheets measuring 10 by 8.75 inches and which measure up to 0.25 inches in thickness. Each cover board 20A/20B is 9.0 by 9.69 inches, with the spine board 20C being 9.0 by 0.375 inches. The gutter regions between the respective edges of the spine board 20C and the edges of the cover boards 20A/20B are each 0.563 inches. Those skilled in the art are cable of making appropriate adjustments in these dimensions for stacks of differing sizes.

FIG. 2 shows further details regarding the construction of the FIG. 1 hardcover assembly 20. The cover and spine boards 20A/B/C are supported on a laminated sheet 21 which includes a layer 22 of hot melt adhesive, a paper liner 24 typically made from Kraft paper, a layer 26 of pressure sensitive adhesive (psa) and a layer 28 which forms a release liner. Layer 28 is a single sided release liner having a silicone coating on only one side contacting the underlying pressure sensitive adhesive layer 26.

All of the layers of the laminated sheet 21 are cut to the same size at one time during the manufacture of the cover assembly 20. Assuming that the cover board 20A/20B and spine board 20C dimensions are as described above, the length of the laminated sheet is 22 inches, with the width being 10.1 inches. The four corners of sheet 21 are chamfered at 450, with the cuts being located at 1.2 inches from the corners.

The laminated sheet 21 is wrapped around the cover board 20A/20B and spine board 20C arrangement during the manufacturing process. The sheet 21 is secured to the underside of the boards by way of adhesive 22, with the adhesive securing the three boards in the desired position. The respective four edges of sheet 21 are then wrapped around the respective edges of the cover and spine boards and also secured in place by adhesive 22. FIG. 3 is a schematic representation of an exemplary edge of the resultant structure taken at section line 3-3 of FIG. 1 of cover section 20A with the thickness of the various layers being exaggerated for purposes of clarity. The edge of sheet 21 extends around the edges of the cover boards to form sections 28A/28B/28C and 28D. These sections each extend over the other side of the boards a distance D (FIG. 3) of approximately 0.57 inches. The chamfered corners of sheet 21 result in a mitered corner fold as can be seen in FIG. 1. A gap having a width G (FIG. 1) of about 0.16 inches is produced when the mitered corners are formed.

As previously noted, the hardcover assembly 20 as shown in FIG. 1 is preferably manufactured at low cost using automated mass production methods. An end user purchases one of the assemblies having dimensions appropriate for the media to be bound. Typically, the end user provides a custom over-wrap sheet which is cut into the proper size as will be described. The over-wrap sheet is preferably made of well known materials suitable for covering a hardcover book including, for example, composition material, art or library cloth or photographic paper. The over-wrap sheet typically includes customized graphics including a title and the like which can be added by the end user using printers and the like. Once any desired graphic have been added to the over-wrap sheet, the end user begins the process of attaching the over-wrap sheet to the cover assembly 20 by removing the release liner 28 so as to expose the underlying pressure sensitive layer 26. The over-wrap sheet is then secured to cover assembly by way of the exposed layer 26.

Various approaches for cutting an over-wrap sheet and applying the sheet to a cover assembly are disclosed in U.S. Pat. No. 7,452,172 entitled “Method of Making and Applying a Hardcover Over-Wrap and Guide Apparatus” which issued on Nov. 18, 2008. U.S. Pat. No. 7,452,172, the contents of which are fully incorporated herein by reference, describes the manner in which an over-wrap sheet can be accurately cut and then secured to a hardcover assembly using low cost desktop equipment. Once the over-wrap sheet is applied to the hardcover assembly 20, the edges of the sheet are folded around the edges of the assembly as further described in U.S. Pat. No. 7,452,172.

Although not depicted in the drawings, the inner surfaces of the cover boards 20A/20B are provided with a combination of pressure sensitive adhesives and associated release liners which permit a bound stack to be encased by the hardcover assembly 20 and associated over-wrap sheet 30. Again, U.S. Pat. No. 7,452,172 discloses exemplary apparatus for securing the hardcover assembly to a bound stack.

As previously noted, once a manufactured hardcover assembly is provided, a customized over-wrap sheet can be readily added using desktop equipment. As shown in FIG. 4. a template 34, preferably made of transparent plastic, is used having dimensions that are appropriate for the dimensions of the prefabricated hardcover assembly 20. The exterior dimensions of template 34 correspond to the final dimensions of the over-wrap sheet, including the edges of the sheet that will be wrapped around the edges of the hardcover assembly as will be described. The template 34 is shown in FIG. 4 placed over an uncut over-wrap sheet 32, with any graphics on sheet 32 not being depicted. Transparent template 34 includes indicia 38 surrounding those portions of the over-wrap which will be visible on the exterior of the book, with the remaining portions being wrapped around the edges of the hardcover assembly. Template 34 includes respective vertical and horizontal reticules 36A and 36B used to accurately align the template over the uncut over-wrap sheet relative to the graphics on the sheet. Vertical reticule 36A, which aligns the graphics to that region of the sheet which will be eventually located on the spine of the final book, is typically positioned over the title graphics. Reticule 36B is used to adjust the template along an axis perpendicular to the spine of the book.

Once the template 34 has correctly positioned, the outer dimensions of the template are used as a guide for cutting the over-wrap sheet to form a cut sheet 30. Cut sheet 30 includes four extensions 30A, 30B, 30C and 30D which extend past indicia 38 and which will be wrapped around the edges of the hardcover assembly as will be described.

Cut sheet 30 is then applied to the pre-manufactured hardcover assembly. Since proper alignment between sheet 30 and the hardcover assembly 20 is critical, a manually operated and low cost prior art wrapping machine 40 as shown in FIGS. 5-7 is preferably used for this purpose. Wrapping machine 40 typically rests on a desktop (not depicted), with a forward portion of the machine extending past the edge of the desktop. Machine 40 includes a flat work area 42 coated with a silicone material which resists adhesion to the pressure sensitive adhesives. A fixed guide 48 is provided adjacent the work surface having centering indicia 50. Fixed guide 48 includes a guide extension 48A that extends along a full length of guide 48, with the extension having a width equal to the widths of the over-wrap extensions 30A, 30B, 30C and 30D. A movable guide 46 is mounted on the fixed guide 48 for movement along guide 48. Moveable guide 46 also includes a guide extension 46A, with the width of extension 46A also equal to that of the over-wrap extensions 30A, 30B, 30C and 30D.

Initially, a hardcover assembly to be covered is positioned on the work surface 42. Prior to such positioning, the release liner 28 is manually removed so as to expose the underlying layer 26 of pressure sensitive adhesive. The user separates a small portion of an edge of the release liner 28 from the underlying pressure sensitive adhesive 26 (see FIG. 3 where only portions 26A and 28A are depicted) at one or more locations and then pulls the separated liner portion away from the adhesive, taking care not to permit the exposed adhesive to prematurely contact any surfaces. When the liner is removed, one side of the hardcover assembly is completely covered by the pressure sensitive adhesive layer 26, with the opposite side of the assembly having exposed segments of adhesive, such as segment 26A of FIG. 3 (shown not yet exposed).

The hardcover assembly 20 is then positioned on the work surface 42, with the side completely covered by pressure sensitive adhesive 26 facing upward. Thus, the cover and spine boards along with the exposed adhesive segments, including segment 26A, are resting on the work surface. Prior to such positioning, movable guide 46A is moved to the extreme left. The silicone coating on the work surface 42 prevents the adhesive segments from adhering too strongly to the work surface. The cover assembly is positioned so that the underlying spine board 20C is adjacent the center indicia 50 of the fixed guide 40, with the edge of the cover assembly abutting guide extension 48A. At this point the hardcover assembly is at the desired location, with the limited tackiness of the adhesive segments, including segment 26A, on the silicone surface tending to secure the assembly in place. Next, the movable guide 46 is moved to the right until the guide extension 46A abuts an edge of the cover assembly.

The cut over-wrap sheet 30 is the positioned over the hardcover assembly, with the respective orthogonal edges of sheet 30 abutting the edges of guides 46 and 48. The width of the guide extensions 46A and 48A function to locate the cover assembly relative to the over-wrap sheet 30 so that the hardcover assembly is aligned relative to the sheet as shown by template markings 38 in FIG. 4. Care is taken so that the sheet 30 is first tacked in place at two spaced apart locations to secure and maintain proper alignment. Once proper alignment is achieved, the user manually presses sheet 30 down onto the hardcover assembly, preferably starting at one end as depicted in FIG. 5, and moving to the opposite end while taking care not to create air pockets until the sheet is secured to the entire upper surface of hardcover assembly.

In some cases where alignment of the over-wrap sheet 30 with respect to the book spine is critical, the guide extension 46A may not provide sufficient accuracy for setting the horizontal location of the sheet over the hardcover assembly. Typically this may be due to small misalignments in the cutting of the sheet 30. In that case, the horizontal positioning of sheet 30 is carried out by centering that part of the sheet 30 to form the spine just above center indicia 50 rather than relying on extension 46A.

Rather than removing the entire release liner 28 in one step, the user could separate only a portion of the release liner at a time and then secure the over-wrap sheet 30 to that exposed portion. A further portion of the release liner can then be removed and the sheet 30 secured to the resultant exposed adhesive until all of the sheet is secured by the adhesive. The advantage of this sequential process is that the application of the over-wrap sheet to the adhesive layer is well controlled so that the sheet can more easily be secured without the introduction of wrinkles and air pockets between the sheet and the adhesive.

At this point, the over-wrap sheet extensions 30A, 30B, 30C and 30D extend away from the hardcover assembly and need to be folded around the respective edges of the assembly and secured in place by the respective pressure sensitive adhesive sections 26A, 26B, 26C and 26D. This is accomplished by the pinch roller assembly of wrapping machine 40 made up of rotatably mounted rollers 44A and 44B. Rollers 44A/44B, which are provided with silicone covered surfaces, are forced together by a pair of spring assemblies 45A and 45B located at opposite ends of the rollers. The user sequentially secures each over-wrap sheet extension, one extension at a time. By way of example, FIGS. 6 and 7 shows the edge of the assembly with extension 30A being inserted between rollers 44A and 44B. The user forces the assembly down between the rollers, as indicated by arrow 43 of FIG. 7, with the downward force causing the spring assemblies 45A and 45B to expand so that the rollers separate to receive the assembly. The spring assemblies apply a compressing force which folds the cover wrap sheet extension 30A tightly around the edge of the hardcover assembly and then forces the extension against the underlying pressure sensitive adhesive segment 26A. The assembly is forced down only a distance needed to secure extension 30A and is then withdrawn as indicated by arrow 43 of FIG. 6. FIG. 8 is a simplified cross-section of one edge of the hardcover assembly after this procedure is completed for extension 30A. The procedure is repeated for the remaining three extensions 30B, 30C and 30D. Once all four extensions are folded and secured, the entire assembly can be passed through the pinch rollers to ensure that the entire over-wrap sheet is secured. Once the sheet is in place, the covered hardcover assembly can be used to encase a bound stack of sheets as described in U.S. Pat. No. 7,452,172.

The above-described procedure and apparatus for adding a custom over-wrap sheet is advantageous in several respects. One shortcoming arises out of the need to manually separate the release liner 28 from the layer 26 of pressure sensitive adhesive. As can be seen in FIG. 3, it is relatively difficult for a user to grip an edge of the release liner 28A in one or more locations and separate the liner from the underlying aggressive pressure sensitive adhesive layer 26A. This is particularly true since, as previously described in connection with FIG. 2, the release liner 28 and adhesive layer 26 are part of a laminated sheet 21, with sheet 21 being cut to size during manufacture so that the ends of the release liner and adhesive layer are exactly aligned with one another and difficult to manually separate. Furthermore, it has been found that the cutting of the laminated sheet has a tendency to cause some of the fibers in the release liner 28 to combine with the pressure sensitive adhesive thereby increasing the difficulty in separating the release liner from the adhesive.

As will become apparent from a reading of the following Detailed Description of the Invention together with the drawings, the present invention addresses this and other shortcomings of the prior art approaches to hardcover assemblies.

### SUMMARY OF THE INVENTION

A hardcover assembly arrangement is disclosed. The arrangement includes at least first and second hardcover assemblies, with each assembly including a layer of pressure sensitive adhesive disposed on a first surface of the hardcover assembly and additional pressure sensitive adhesive disposed on a second surface of the hardcover assembly. In addition, a release liner is disposed over and contacting the layer of pressure sensitive adhesive on the hardcover assemblies.

The first and second hardcover assemblies are positioned relative to one another such that the release liner of the first hardcover assembly is disposed over and contacts the additional pressure sensitive adhesive of the second hardcover assembly. Thus, the likelihood that the additional pressure sensitive adhesive of the second hardcover assembly will make a premature contact is substantially reduced.

In addition, a method of applying an over-wrap sheet to a hardcover assembly is disclosed. The method includes providing a preassembled hardcover assembly which includes a layer of pressure sensitive adhesive on an exterior surface of the hardcover assembly and a release liner extending over and contacting the layer of pressure sensitive adhesive, with the release liner including at least one extension segment which extends past an edge of the layer of pressure sensitive adhesive layer. The preassembled hardcover assemblies are provided in a container.

The method further includes providing an over-wrap sheet which can be readily customized by the user by adding graphics and the like. The user then manually separates the release liner from the hardcover assembly utilizing the at least one extension segment so as to expose at least part of the layer of pressure sensitive adhesive. The over-wrap sheet is then secured to the hardcover assembly by way of the layer of pressure sensitive adhesive. It is possible to sequentially expose part of the adhesive while securing the over-wrap sheet to that part of the exposed adhesive, continuing this alternating process until all of the over-wrap sheet is secured to the hardcover assembly.

### BRIEF DESCRIPTION OF THE DRAWINGS

FIG. 1 is a plan view of a prior art hardcover assembly before application of an over-wrap sheet.

FIG. 2 is an exploded perspective view of the various layers that make up the prior art hardcover assembly of FIG. 1.

FIG. 3 is a schematic cross-sectional view of part of the prior art hardcover assembly taken through section line 3-3 of FIG. 1.

FIG. 4 is a plan view of a template positioned over an uncut over-wrap sheet.

FIG. 5 is a perspective view of a prior art wrapping machine being used to apply a cut over-wrap sheet to a hardcover assembly.

FIG. 6 is a perspective view of the prior art wrapping machine being used to fold and secure the edges of a cut over-wrap sheet to a hardcover assembly.

FIG. 7 is a schematic view of an edge of a hardcover assembly being inserted between the pinch rollers of the FIG. 6 wrapping machine so as to secure the over-wrap sheet to that edge.

FIG. 8 is a schematic cross-sectional view of part of the prior art hardcover assembly with the over-wrap sheet applied.

FIG. 9 is a schematic cross-sectional view of part of a preassembled hardcover assembly with the periphery of the release liner separated extending away from the edge of the hardcover assembly.

FIG. 10A is a perspective exploded top view of a nested arrangement of hardcover assemblies in accordance with one embodiment of the present invention.

FIG. 10B is a perspective exploded bottom view of the nested arrangement of hardcover assemblies of FIG. 10A.

FIG. 10C is a perspective top view of the nested arrangement of hardcover assemblies of FIGS. 10A and 10B.

FIG. 11 is a schematic representation of a nested arrangement of hardcover assemblies such as depicted in FIG. 10C disposed in a shipping container.

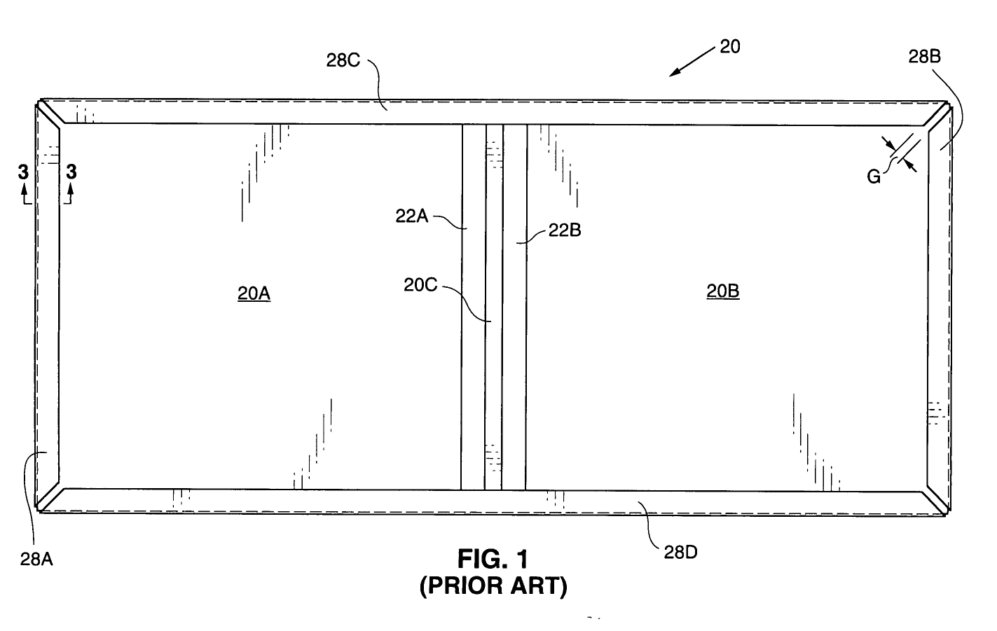

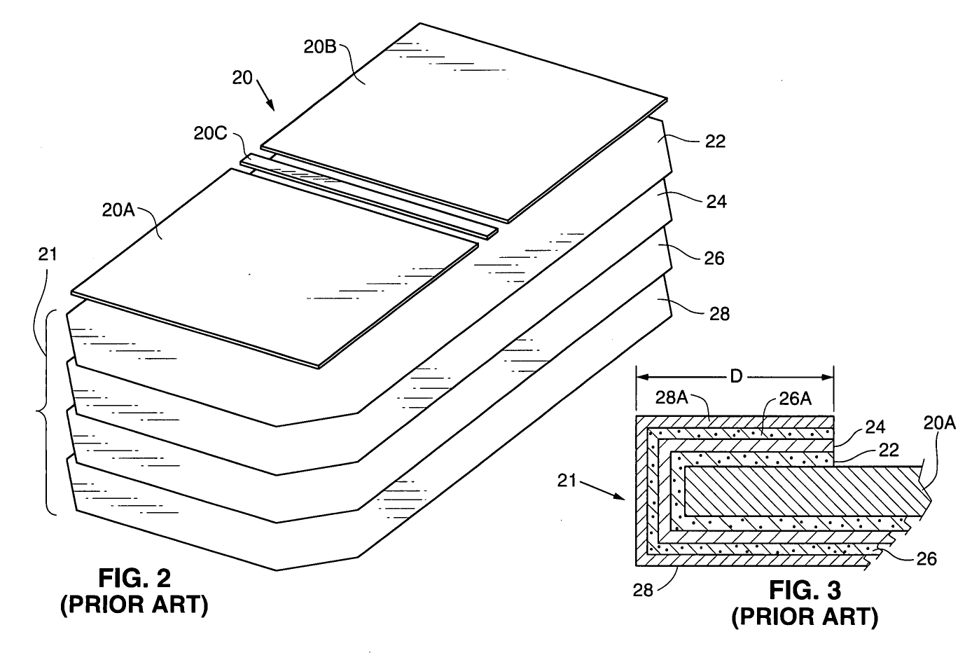

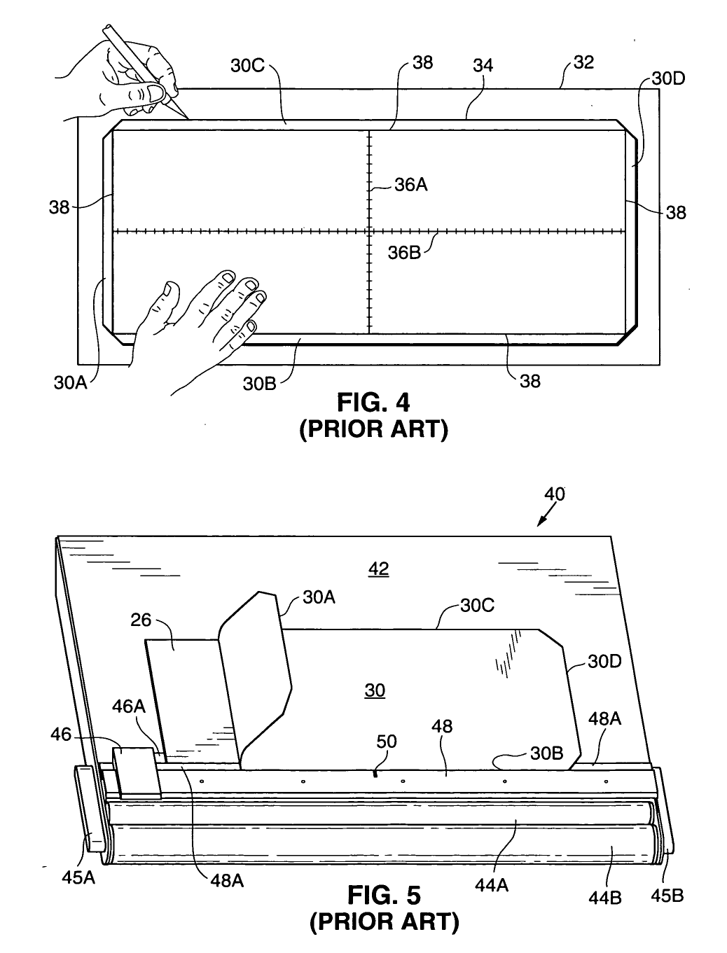

### DETAILED DESCRIPTION OF THE INVENTION

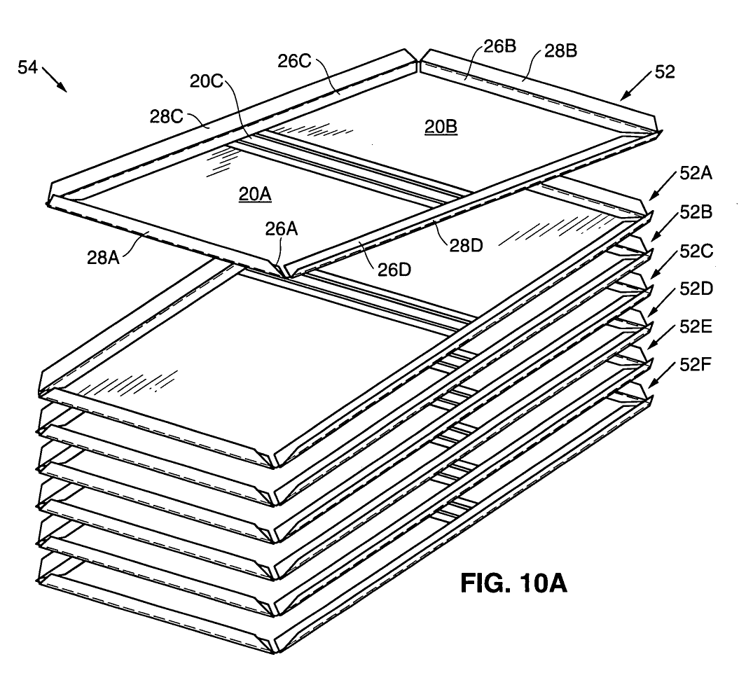

Referring again to the drawings, FIG. 9 shows a schematic representation of a modified preassembled hardcover assembly 52 with the same numerical identifiers generally designating similar components as the prior art assemblies previously described. For reasons that will become apparent, the release liner 28 of modified assembly 52 is double sided, which means that both surfaces are coated, typically with a silicone material, to resist adhering to a pressure sensitive adhesive. As is the case of the prior art hardcover assemblies, assembly 52 includes an inner surface which usually is, or will be, attached to an end leaf. In addition, assembly 52 includes an exterior surface which will eventually be completely covered by an over-wrap sheet. As shown in FIG. 9, during the manufacturing process release liner segments 28A, 28B, 28C and 28D (only 28A is depicted) are formed so as to extend away from the inner surface and edges of the hardcover assembly. Thus, the release liner segments, including segment 28A, do not contact the pressure sensitive adhesive sections, such as section 26A, disposed on the interior surface of the assembly. In addition, the release liner segments may or may not contact the pressure sensitive adhesive located on the edges of the hardcover assembly such as edge adhesive 27A.

A person skilled in the art of manufacturing hardcover assemblies would be capable of modifying the conventional manufacturing equipment so that the release liner segments are not disposed on the inner surface of the hardcover assemblies. By way of example, the hardcover assemblies can be manufactured in accordance with the prior art with additional mechanisms added to the manufacturing equipment that lifts the release liners off the adhesive located on the interior surface such as adhesive section 26A.

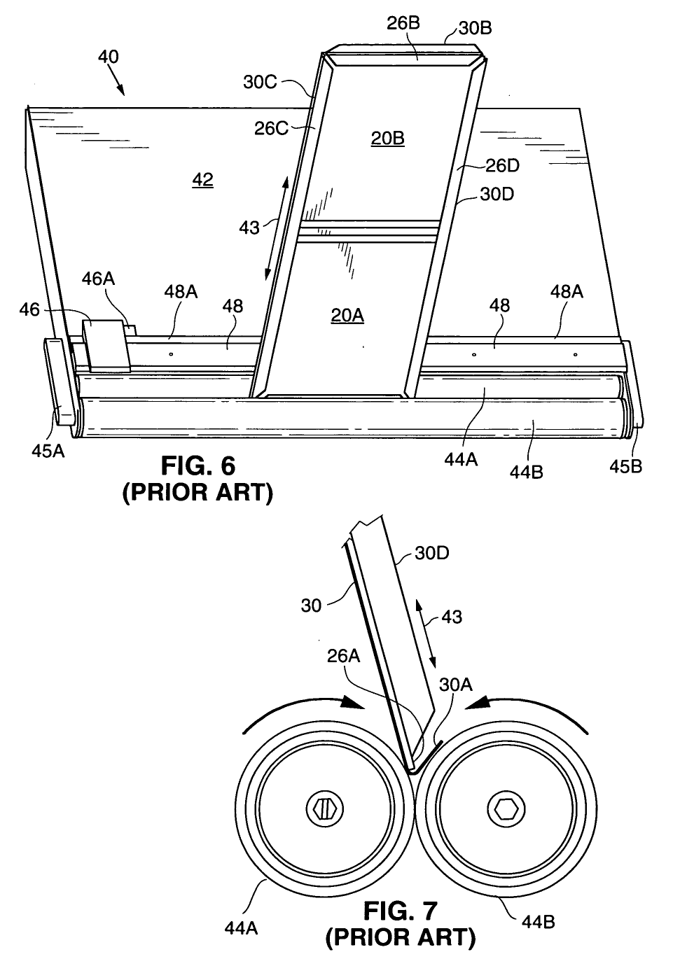

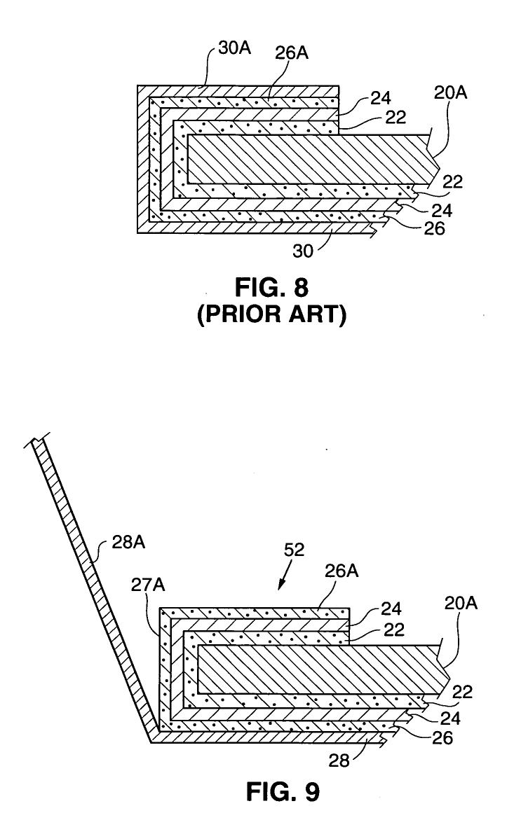

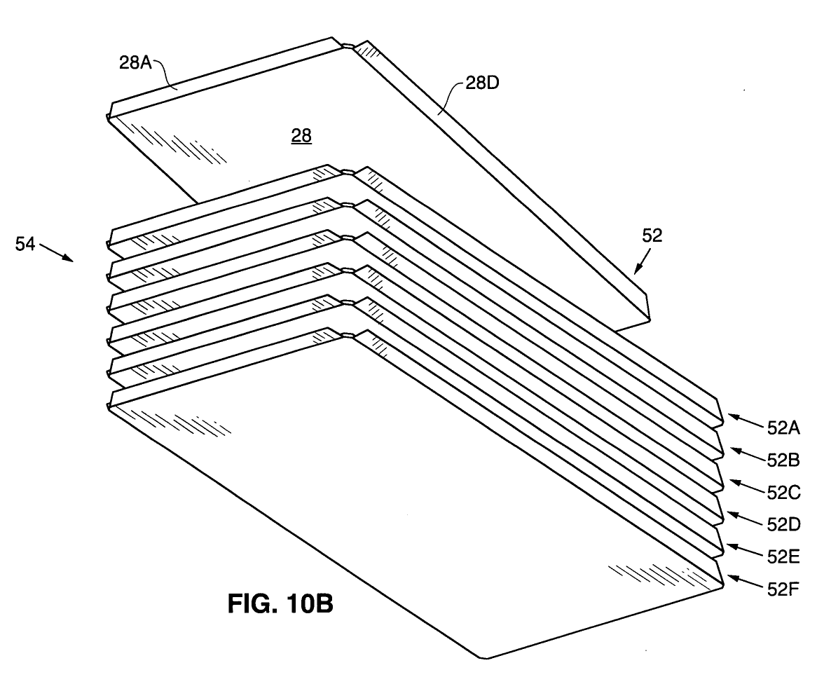

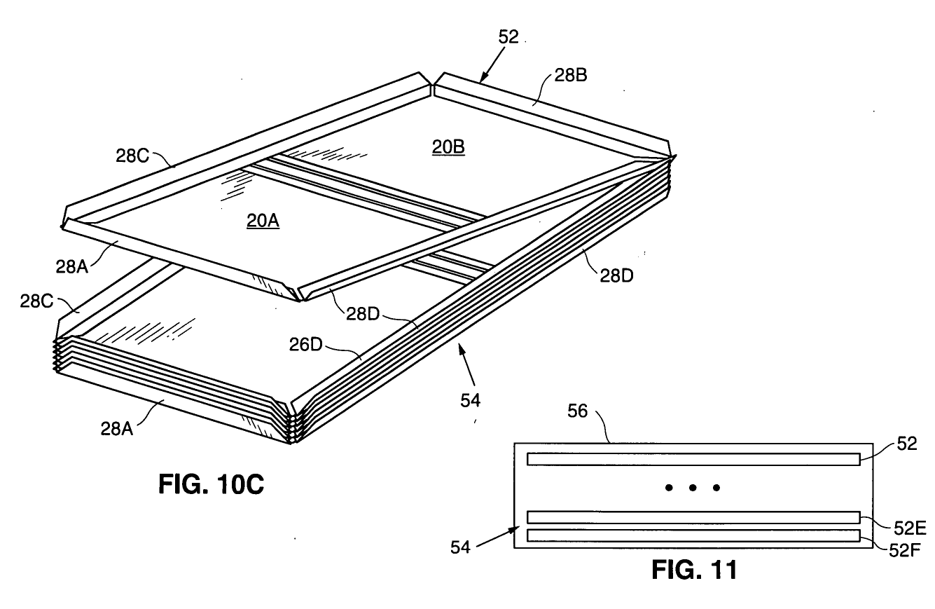

In order to prevent the exposed pressure sensitive adhesive, such as adhesive 26A becoming prematurely attached to a surface during shipping, handling and the like, multiple assemblies 52 are nested together as depicted in FIGS. 10A, 10B and 10C to form a hardcover assembly arrangement 54. These figures show, by way of example, seven assemblies 52 arranged such that release liner 28 (see FIG. 10B) of a first assembly, assembly 52A for example, rests on the otherwise exposed adhesive segments 26A, 26B, 26C and 26D of a second assembly located immediately below the first assembly, such as assembly 52B for example. As can best be seen if FIG. 10C, the nested arrangement 54, shown in a generally horizontal position, allows a relatively large number of individual hardcover assemblies 52 to be combined in a small volume to form the arrangement 54. Preferably, the arrangement 54 is disposed in a container 56 as depicted schematically in FIG. 11 for shipping and storing the assemblies until needed by the end user. The container 54 is sized such that the nested stack 54 of hardcover assemblies retain their relative alignment as shown in FIG. 10C during shipping, even when the container is rotated about any axis. Since the uppermost hardcover assembly 52 is not covered by another assembly, the uppermost assembly is preferably covered by a flat sheet of release liner material (not depicted) so that it does not adhere to the inner surface of the container. Once the container is opened for use after shipping, the container can easily be maintained in a horizontal position to that the flat sheet can be discarded if desired. Thus, the user need not be concerned with any exposed pressure sensitive adhesive, with the upper assembly adhesive being displaced from the upper interior surface of the container by gravity. The user can easily remove an individual hardcover assembly 52 from the container, starting at the top of the stack, by gripping one of the extended release liner segments 28A, 28B, 28C or 28D. The user can then readily remove the entire release liner 28 from the hardcover assembly by gripping one or more of those liner segments and pulling the assembly and release liner apart thereby exposing the remaining pressure sensitive adhesive 26 located on the exterior surface of the hardcover assembly. Finally, a cut over-wrap sheet 30 can be applied to the assembly in the same manner as previously described in connection with FIGS. 5-7.

Thus, a novel hardcover assembly arrangement and related methods have been disclosed. Although the disclosed embodiment has been described in some detail, those skilled in the art would recognize that certain changes can be made without departing from the spirit and scope of the present invention as defined by the appended claims.

1. A hardcover assembly arrangement comprising:
a first hardcover assembly including
(a) a layer of pressure sensitive adhesive disposed on a first surface of the first hardcover assembly and additional pressure sensitive adhesive disposed on a second surface of the first hardcover assembly, opposite the first surface,
(b) a release liner disposed over and contacting the layer of pressure sensitive adhesive on the first hardcover assembly, and
a second hardcover assembly including
(a) a layer of pressure sensitive adhesive disposed on a first surface of the second hardcover assembly and additional pressure sensitive adhesive disposed on a second surface of the second hardcover assembly, opposite the first surface,
(b) a release liner disposed over and contacting the layer of pressure sensitive adhesive of the second hardcover assembly, and
wherein the first and second hardcover assemblies are positioned relative to one another such that the release liner of the first hardcover assembly is disposed over and contacts the additional pressure sensitive adhesive of the second hardcover assembly.

2. The hardcover assembly arrangement of claim 1 wherein the release liner of the first hardcover assembly is a double sided release liner.

3. The hardcover assembly arrangement of claim 1 further comprising:
a third hardcover assembly including
(a) a layer of pressure sensitive adhesive disposed on a first surface of the third hardcover assembly and additional pressure sensitive adhesive disposed on a second surface of the third hardcover assembly, opposite the first surface,
(b) a release liner disposed over the layer of pressure sensitive adhesive of the third hardcover assembly, and
wherein the second and third hardcover assemblies are positioned relative to one another such that the release liner of the second hardcover assembly is disposed over and contacts the additional pressure sensitive adhesive of the third hardcover assembly.

4. The hardcover assembly arrangement of claim 3 wherein the release liner of the second hardcover assembly is a double sided release liner.

5. The hardcover assembly arrangement of claim 3 wherein the additional pressure sensitive adhesive of the first, second and third hardcover assemblies is disposed exclusively around a periphery of the second surfaces of the respective first, second and third hardcover assemblies.

6. The hardcover assembly arrangement of claim 3 wherein each of the hardcover assemblies includes an edge region located intermediate, and generally orthogonal to, the first and second surfaces, and wherein the edge regions are substantially covered by still further pressure sensitive adhesive.

7. The hardcover assembly arrangement of claim 4 wherein the release liners of the first, second and third hardcover assemblies each extend past an edge of each of the layers of pressure sensitive adhesive at at least one location of the edge of each of the layers of pressure sensitive adhesive.

8. The hardcover assembly arrangement of claim 3 further including a container which encloses the first, second and third hardcover assemblies, with the container having dimensions that maintain the relative positions of the first, second and third hardcover assemblies when the container is rotated about any axis.

9. A method of applying a over-wrap sheet to a hardcover assembly comprising:
providing a preassembled hardcover assembly disposed in a container, with the hardcover assembly including a layer of pressure sensitive adhesive on an exterior surface of the hardcover assembly and a release liner extending over and contacting the layer of pressure sensitive adhesive, with the release liner including at least one extension segment which extends past an edge of the layer of pressure sensitive adhesive layer;
providing an over-wrap sheet;
removing the preassembled hardcover assembly from the container;
manually separating the release liner from the hardcover assembly utilizing the at least one extension segment so as to expose at least part of the layer of pressure sensitive adhesive; and
securing the over-wrap sheet to the hardcover assembly by way of the layer of pressure sensitive adhesive.

10. The method of claim 9 where the providing includes providing an arrangement of plural preassembled hardcover assemblies disposed in the container.

11. The method of claim 10 wherein the arrangement of plural preassembled hardcover assemblies are arranged such that the release liner of one hardcover assembly is disposed over and contacts pressure sensitive adhesive located on an adjacent one of the hardcover assemblies.

12. The method of claim 11 wherein the container is dimensioned such that relative positions of the hardcover assemblies are maintained when the container is rotated about any axis.

13. The method of claim 8 wherein the manually separating includes manually gripping the at least one extension segment.
